(19) United States
(12) Patent Application Publication
(10) Pub. No.: US 2018/0202592 A1
(43) Pub. Date: Jul. 19, 2018

(54) QUICK CONNECT ASSEMBLY

(71) Applicant: AIR INTERNATIONAL (US) INC., Auburn Hills, MI (US)

(72) Inventor: Wayne Wright, Goodrich, MI (US)

(21) Appl. No.: 15/410,168

(22) Filed: Jan. 19, 2017

(51) Int. Cl. F16L 37/084

(52) U.S. Cl. CPC F16L 37/0844

(57) ABSTRACT

A quick connect assembly according to an example of the present disclosure includes a first member that has a mating section at a first end. A second member includes a protruding portion received against the mating section. A clip is configured to be received within an opening of the first member such that an engagement portion of the clip is received against the protruding portion.

### BACKGROUND

This disclosure relates generally to a quick connect assembly for connecting conduit ends for fluid flow.

### SUMMARY

A quick connect assembly according to an example of the present disclosure includes a first member that has a mating section at a first end. A second member includes a protruding portion received against the mating section. A clip is configured to be received within an opening of the first member such that an engagement portion of the clip is received against the protruding portion.

In a further embodiment of any of the present embodiments, the clip includes an outward portion radially outward of the first member and an engagement portion received against the protruding portion.

In a further embodiment of any of the present embodiments, the mating section includes a radially outward extending surface configured to interface with a first surface of the protruding portion.

In a further embodiment of any of the present embodiments, the engagement portion is received in a slot in the first member axially adjacent to the radially outward extending surface.

In a further embodiment of any of the present embodiments, the clip comprises three engagement portions received in three circumferentially spaced slots in the first member.

A further embodiment of any of the foregoing embodiments includes a radial channel configured to receive the o-ring.

In a further embodiment of any of the present embodiments, the first member is configured to receive a conduit.

In a further embodiment of any of the present embodiments, the clip includes a circumferential opening such that the clip can be attached by moving the clip in a radial direction with respect to the first member.

In a further embodiment of any of the present embodiments, the protruding portion includes a groove configured to receive the engagement portion.

A quick connect assembly according to an example of the present disclosure includes a first member that has a mating section at a first end. A second member includes a protruding portion that has first and second surfaces. The first surface is received against the mating section, and a clip is received against the second surface.

In a further embodiment of any of the present embodiments, the clip includes an outward portion radially outward of the first member and an engagement portion received against the second surface.

In a further embodiment of any of the present embodiments, the clip is received in a slot in the first member.

In a further embodiment of any of the present embodiments, the second surface includes a groove configured to receive an engagement portion of the clip.

A further embodiment of any of the foregoing embodiments includes a radial channel configured to receive the o-ring.

In a further embodiment of any of the present embodiments, the radial channel is axially spaced toward the second end from the radially outward extending surface.

A method for connecting two fluid conduit ends according to an example of the present disclosure includes inserting a male member into a female member. A first surface of a protruding portion of the male member is received against a mating portion of the female member, engaging a clip received against a second surface of the protruding portion.

A further embodiment of any of the foregoing embodiments includes engaging a fluid conduit end to the male member and engaging a second fluid conduit end to the female member.

A further embodiment of any of the foregoing embodiments includes aligning an o-ring within the female member.

These and other features may be best understood from the following specification and drawings, the following which is a brief description.

### BRIEF DESCRIPTION OF THE DRAWINGS

FIG. 1 is a sectional view of an example quick connect assembly.

FIG. 2 is a sectional view of an example quick connect assembly prior to engagement.

FIG. 3 is a sectional view of an example quick connect assembly.

FIG. 4 is an exploded view of the example quick connect assembly of FIG. 3.

FIG. 5 is a perspective view of the example quick connect assembly of FIGS. 3 and 4 after engagement.

FIG. 6 is a perspective view of another example quick connect assembly.

FIG. 7 schematically illustrates a method of assembling a quick connect assembly.

### DETAILED DESCRIPTION

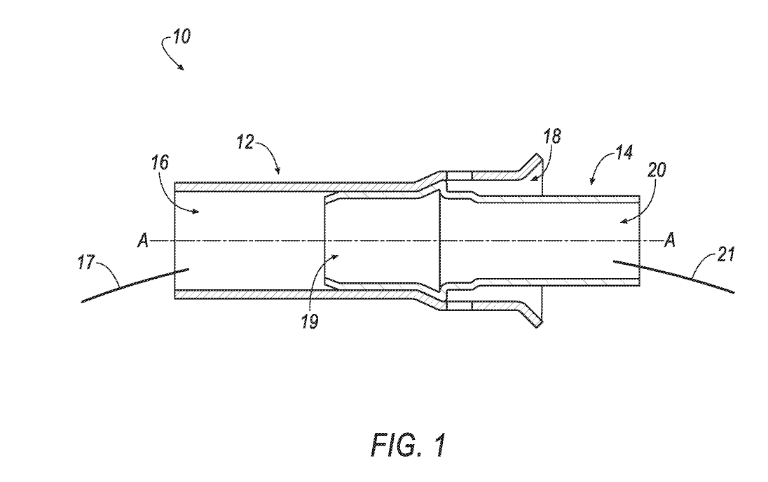

FIG. 1 illustrates an example quick connect assembly 10 including a female member 12 configured to receive a male member 14. The female member 12 and the male member 14 may each be generally cylindrical and disposed about an axis A. The female member 12 includes a first end 16 configured to engage a fluid conduit end 17 (shown schematically) and a second end 18 axially opposite the first end 16 and configured to receive the male member 14. The male member 14 includes a first end 19 configured to be received in the female member 12 and a second end 20 axially opposite the first end 19 configured to engage a fluid conduit end 21 (shown schematically).

In one example, the assembly 10 may be used for the transfer of fluid in vehicles. Example fluids include but are not limited to glycol and water.

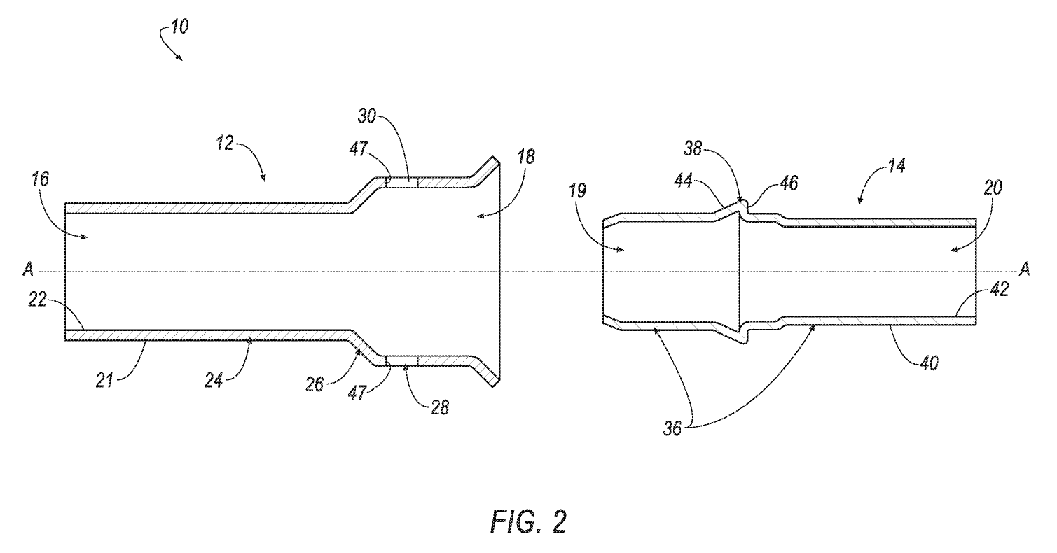

FIG. 2 illustrates an example quick connect assembly 10. The female member 12 and male member 14 are separate before engagement. The female member 12 includes a radially outer surface 21 and a radially inner surface 22. The female member 12 includes a cylindrical section 24 extending axially from the end 16 toward the end 18. The female member 12 includes a mating section 26 that flares radially outward as it extends in a direction from the end 16 toward the end 18. A securing section 28 extends from the mating section 26 toward the end 18 and may include one or more openings or slots 30.

The male member 14 includes a cylindrical body 36 and a protruding portion 38 extending radially outward from the cylindrical body 36. The male member 14 includes a radially outer surface 40 and a radially inner surface 42. The radially outer surface 40 at the protruding portion 38 may include two radially extending surfaces 44, 46. The surface 44 is configured to mate with the radially inner surface 22 of the female member 12 at the mating section 26. The surface 46, when the male member is received in the female member 12 will be axially aligned with the section 28 and/or the openings 30 in the section 28 or edges 47 of the openings 30 closest to the end 16.

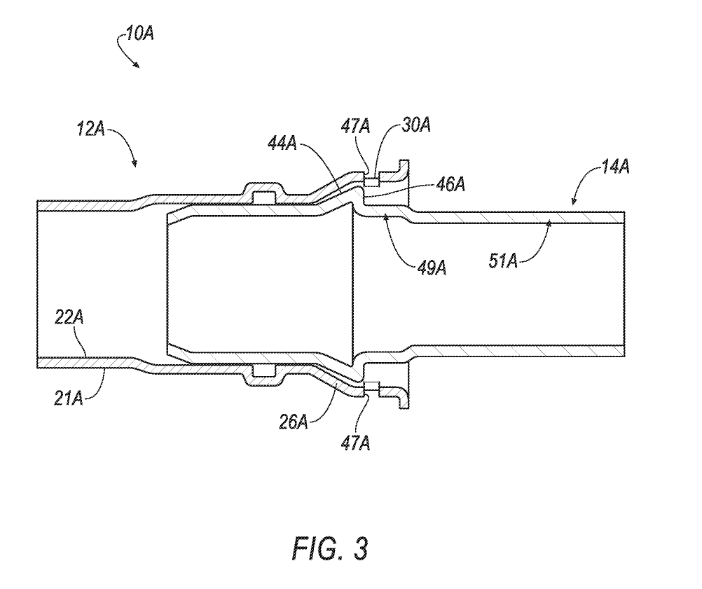

FIGS. 3-5 illustrate the example quick connect assembly 10A. FIG. 3 illustrates a cross-sectional view of an example quick connect assembly 10A having a male member 14A received in a female member 12A. As shown, the tapered surface 44A of the protruding portion 38A mates with the inner surface 22A of the female member 12A at the mating portion 26A. The radially extending surface 46A of the protruding portion 38A is axially aligned with the surfaces 47A of the slots 30A. The radially extending surface 46A may extend from a cylindrical portion 49A radially outward of an adjacent cylindrical portion 51A of the male member 14A. The axial end of the surface 49A may be substantially axially aligned with the axial end of the female member 12A, as a visual aid to the operator that the connection is complete. One of ordinary skill in the art having the benefit of this disclosure would recognize that other surface shapes may be utilized.

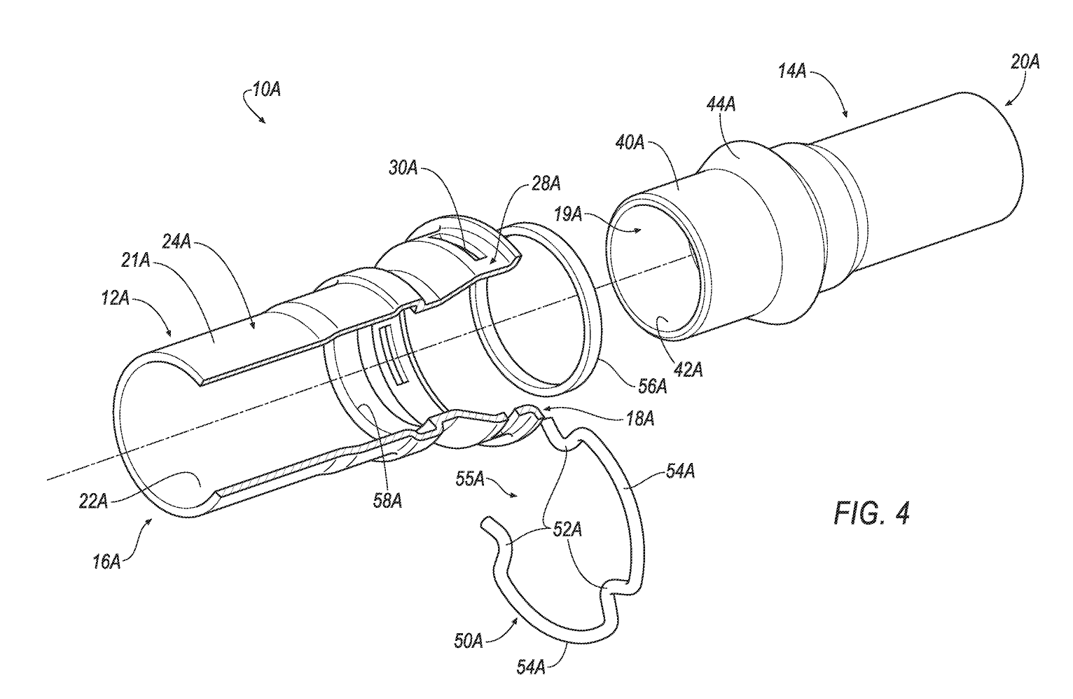

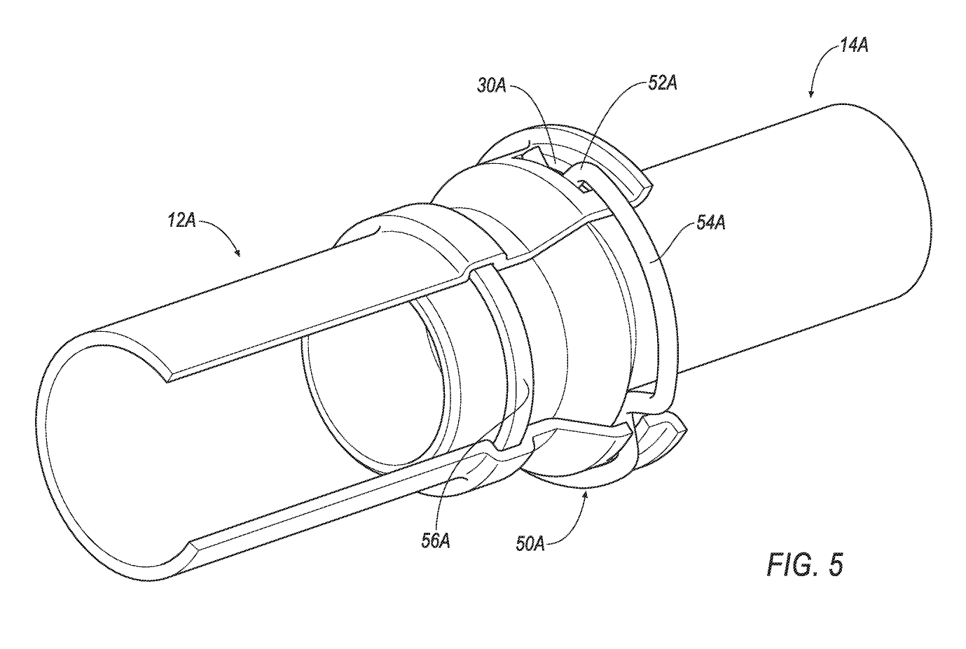

FIG. 4 is an exploded view, and FIG. 5 is an assembled view. A section of the female member 12A is missing in FIGS. 4 and 5 for ease of viewing. The quick connect assembly 10A includes a clip 50A configured to secure the male member 14A inside the female member 12A by biasing the protruding portion 38 against the mating section 26. The clip 50A includes an outer portion 54A and one or more engagement portions 52A which are configured to engage the surface 46A (see FIG. 3) of the male member 14A when the male member 14A is received in the female member 12A. The outer portions 54A will remain radially outward of the outer surface 21A of the female member 12A at the section 28A.

The engagement portions 52A are configured to be received in the openings 30A in the section 28A such that the engagement portions 52A extend radially inward of the inner surface 22A of the female member 12A and engage the surface 46A of the protruding portion 38A of the male member 14A and prevent the male member 14A from moving axially away from the female member 12A, thus keeping the male member 14A and the female member 12A engaged. The mating of the surface 44A of the male member 14A and the inner surface 22A of the female member 12A at the mating section 26A prevents axial movement of the male member in the opposite axial direction.

In one example, the clip 50A is engaged to the female member 12A before the male member 14A is inserted into the female member 12A. The engagement portions 52A engage the ramped surface 44A of the male member as it is being inserted. When the edge 46A becomes aligned with the edge 47A, the engagement portions 52A drop off of the surface 44A and engage the surface 46A.

With axial alignment of the surfaces 47A of the openings 30A with the radially extending surface 46A of the protruding portion 38A when the mating section 26A is engaged with the surface 44A, the engagement portions 52A received against the surface 46A limit axial movement of the male or female members 12, 14 with respect to one another. In one example, the surface 46A forms approximately a 90 degree angle with the adjacent cylindrical surface of the male member 14A to facilitate engagement with the radially extending engagement portions 52A (see FIG. 3), which engage both surfaces 46A and 47A. The axial width of the engagement portions 52A may be substantially the same as the axial width of the openings 30A to further limit axial movement.

In an example, the clip 50A includes three engagement portions 52A circumferentially spaced from one another by approximately 120° between their respective center points. One of ordinary skill in the art having the benefit of this disclosure would recognize that more or fewer engagement portions 52A and variations in spacing could be utilized. The example clip 50A includes a circumferential opening 55A, such that, after the male member 14A is inserted into the female member 12A, the clip 50A can be engaged with the assembly 10A by moving the clip 50A in a direction substantially perpendicular or radial to the axis A.

The quick connect assembly 10A may further include an o-ring 56A for proper fluid sealing. The o-ring 56A may be received in an annular channel 58A at the radially inner surface 22A of the female member 12A at the cylindrical section 24A. The annular channel 58A may be axially spaced from the mating section 26A toward the end 16A of the female member 12A. The o-ring engages the outer cylinder 40A of the male member 14A when assembled.

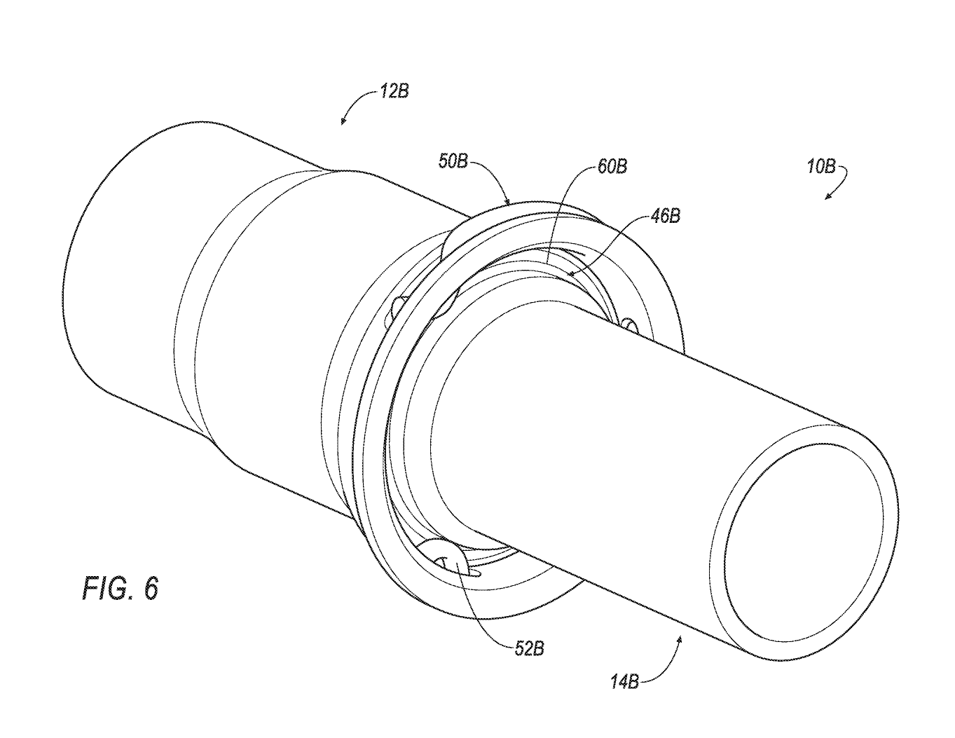

FIG. 6 illustrates an alternate view of an example quick connect assembly 10B when the male member 14B is received in the female member 12B and the clip 50B is engaged. In this example, the surface 46B of the protruding section 38B of the male member may include a groove 68B configured to receive the engagement portions 52B of the clip 50B.

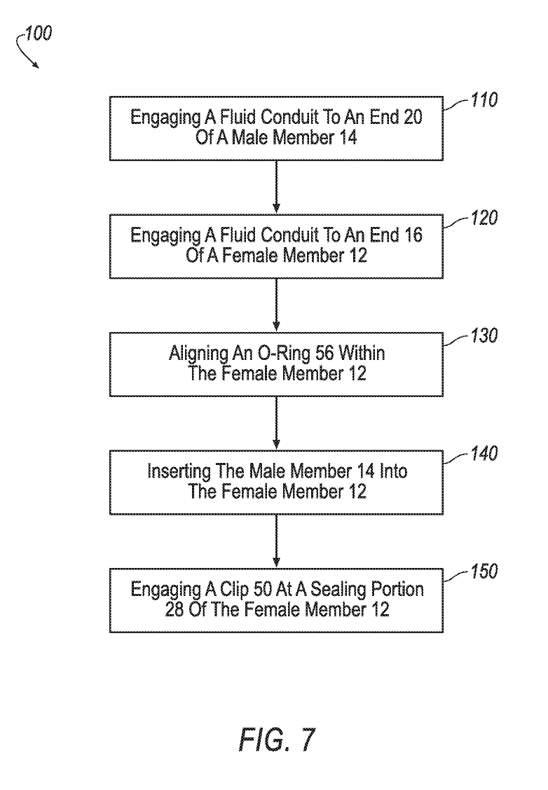

FIG. 7 schematically illustrates a method 100 for connecting two fluid conduit ends utilizing any one of the example embodiments disclosed at FIGS. 1-6. At 110, a fluid conduit end is engaged to the end 20 of the male member 14. At 120, a fluid conduit end is engaged to an end 16 of the female member 12. The respective fluid conduit ends engaged to the male and female members may be part of the same conduit or from separate conduits. Next, at 130, an o-ring 56 may be aligned within the female member 12. At 140, the male member 14 is inserted into the female member 12. At 150, the clip 50 is engaged at the securing section 28 of the female member 12. In one example, step 150 is performed before step 140.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A quick connect assembly, comprising:
a first member having a mating section at a first end;
a second member including a protruding portion received against the mating section;
a clip configured to be received within an opening of the first member such that an engagement portion of the clip is received against the protruding portion.

2. The quick connect assembly as recited in claim 1, wherein the clip includes an outward portion radially outward of the first member and an engagement portion received against the protruding portion.

3. The quick connect assembly as recited in claim 1, wherein the mating section includes a radially outward extending surface configured to interface with a first surface of the protruding portion.

4. The quick connect assembly as recited in claim 3, wherein the engagement portion is received in a slot in the first member axially adjacent to the radially outward extending surface.

5. The quick connect assembly as recited in claim 1, wherein the clip comprises three engagement portions received in three circumferentially spaced slots in the first member.

6. The quick connect assembly as recited in claim 1, further comprising an o-ring, wherein the first member includes a radial channel configured to receive the o-ring.

7. The quick connect assembly as recited in claim 1, wherein the first member is configured to receive a conduit.

8. The quick connect assembly as recited in claim 1, wherein the clip includes a circumferential opening such that the clip can be attached by moving the clip in a radial direction with respect to the first member.

9. The quick connect assembly as recited in claim 1, wherein the protruding portion includes a groove configured to receive the engagement portion.

10. A quick connect assembly, comprising:
a first member having a mating section at a first end;
a second member including a protruding portion having first and second surfaces, wherein the first surface is received against the mating section; and
a clip received against the second surface.

11. The quick connect assembly as recited in claim 10, wherein the clip includes an outward portion radially outward of the first member and an engagement portion received against the second surface.

12. The quick connect assembly as recited in claim 10, wherein the clip is received in a slot in the first member.

13. The quick connect assembly as recited in claim 10, wherein the second surface includes a groove configured to receive an engagement portion of the clip.

14. The quick connect assembly as recited in claim 10, further comprising an o-ring, wherein the first member includes a radial channel configured to receive the o-ring.

15. The quick connect assembly as recited in claim 14, wherein the radial channel is axially spaced toward the second end from the radially outward extending surface.

16. A method for connecting two fluid conduit ends, comprising:
inserting a male member into a female member, wherein a first surface of a protruding portion of the male member is received against a mating portion of the female member; and
engaging a clip received against a second surface of the protruding portion.

17. The method as recited in claim 16, comprising:
engaging a fluid conduit end to the male member; and
engaging a second fluid conduit end to the female member.

18. The method as recited in claim 16, comprising:
aligning an o-ring within the female member.
